(19) United States
(12) Patent Application Publication
(10) Pub. No.: US 2009/0207040 A1
(43) Pub. Date: Aug. 20, 2009

(54) REMOTE CONTROLLER

(75) Inventor: Takaya Nakamura, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/372,922

(22) Filed: Feb. 18, 2009

(30) Foreign Application Priority Data
Feb. 19, 2008 (JP) 2008-036823

(51) Int. Cl. G08C 19/16

(52) U.S. Cl. 340/825.69

(57) ABSTRACT

A remote controller includes a board, first and second arms, an electrostatic touch panel placed on a first upper end of the first arm and a second upper end of the second arm, a push switch provided between the electrostatic touch panel and the board, a control section, and a transmitter transmitting a remote control signal. The touch panel has an upper surface and a lower surface facing the upper surface of the board. The upper surface of the touch panel is adapted to have a user touch thereon. The push switch is activated upon pressed with the touch panel. The control section detects a position on the upper surface of the electrostatic touch panel where the user touches. The transmitter transmits the remote control signal according to the detected position and an activation of the push switch. This remote controller operates remotely control an electronic device reliably without malfunctioning.

### FIELD OF THE INVENTION

The present invention relates to a remote controller used for remotely controlling an electronic device.

### BACKGROUND OF THE INVENTION

Various electronic devices, such as television receivers, video recorders, or air conditioners, have been recently become more sophisticated, and remote controllers have been accordingly demanded to operate the devices in various reliably.

FIG. 5 is a cross-sectional view of a conventional remote controller 501. Electrostatic touch panel 52 is mounted at an opening provided in an upper surface of case 1 made of insulating resin and having substantially box shape. Electrostatic touch panel 52 includes upper cover 3 made of insulating resin, lower cover 4 made of insulating resin, and electrostatic touch panel element 2 provided between upper cover 3 and lower cover 4. Electrostatic touch panel element 2 includes a sheet having a film shape and plural conductors having substantially strip shapes provided on upper and lower surfaces of the sheet. The conductors extend perpendicularly each other with a predetermined distance. Electrostatic touch panel element 2 includes tail 2A having terminals connected with the conductors. Tail 2A extends rightward out of a lower surface of lower cover 4.

Wiring patterns are provided on upper and lower surfaces of circuit board 5. Push switch 6 is mounted on the upper surface of circuit board 5. Push button 6A projecting from an upper surface of push switch 6 contacts the lower surface of lower cover 4. Electrostatic touch panel element 2 of electrostatic touch panel 52 is connected electrically with the wiring patterns of circuit board 5 via tail 2A and connectors.

Button 7 made of insulating elastic material, such as rubber, has a thin wall portion at the lower part of button 7. The thin wall portion has substantially ring shape. An upper surface of button 7 projects from a through-hole provided in the upper surface of case 1 to allow button 7 to move vertically. Movable contact 7A is provided on a lower surface of button 7. Fixed contacts 5A are provided on the upper surface of circuit board 5. Movable contact 7A faces fixed contacts 5A with a predetermined distance.

Transmitter 8 implemented by, e.g. a light emitting diode (LED) sending a remote signal and control section 9 are mounted on the upper and lower surfaces of circuit board 5. Control section 9 implemented by a semiconductor device, such as a microcomputer, is connected to transmitter 8, electrostatic touch panel 52, push switch 6, and plural fixed contacts 5A via the wiring patterns. Cover 10 made of insulating resin covers a lower surface of case 1.

An operation of remote controller 501 will be described below. A user directs remote controller 501 toward an electronic device to and presses the top of certain button 7. Upon being pressed, button 7 moves downward while the thin wall portion elastically deforms, thereby contacting movable contact 7A on the lower of button 7 electrically with fixed contacts 5A. This operation connects fixed contacts 5A electrically with each other via movable contact 7A. In response to this electrical connection, control section 9 sends an infrared signal to the electronic device from transmitter 8 to control the device remotely, for example, to turn on and off the device or to control volume.

While programs or menus are displayed on a display screen of the electronic device, the user has a finger touch an upper surface of upper cover 3, i.e., an upper surface of electrostatic touch panel 52, and moves the finger in a front, back, right, or left direction on the upper surface to slide on the surface. Electric charges in electrostatic touch panel element 2 flow to the finger, and change the capacitance of the touched position of the conductors. Control section 9 detects the position of electrostatic touch panel 52 where the finger touches.

Control section 9 sends a remote signal corresponding to the position to the electronic device from transmitter 8 to move a cursor or pointer on the display screen in response to the movement of the finger, thereby selecting programs or menus.

FIG. 6 is a cross-sectional view of conventional remote controller 501 while upper cover 3 is pressed. When the cursor or the pointer is positioned at a desired program or menu, the user presses the upper surface of upper cover 3 with the finger as shown in FIG. 6. Upon being pressed with the finger, electrostatic touch panel 52 moves downward and, the lower surface of electrostatic touch panel 52 presses push button 6A of push switch 6, thereby activating push switch 6. Control section 9 detects the activation of push switch 6 and directs transmitter 8 to send a remote control signal, thereby allowing the electronic device to display the program or the next menu.

When the pressing of upper cover 3 is released, push button 6A moves upward pushed by a resilient force of push switch 6. Lower cover 4 and electrostatic touch panel 52 accordingly move upward pushed by push button 6A and return to a position shown in FIG. 5.

Thus, the conventional remote controller 501 remotely controls the electronic device by the pressing of plural buttons 7, selects a menu displayed on a display screen with the touching of electrostatic touch panel 52, and further remotely fixes a menu or displays the next menu with the pressing of electrostatic touch panel 52.

FIG. 7 is a cross-sectional view of conventional remote controller 501 while a periphery of electrostatic touch panel 52 is pressed. When electrostatic touch panel 52 is pressed at the periphery instead of a center portion, push button 6A of push switch 6 is pressed with upper cover 3 and lower cover 4 which incline. Push button 6A may not be pressed by a predetermined distance enough to activate push switch 6, and may activate push switch 6 unstably, hence causing the electronic device to operate erroneously in different manner the user intends.

### SUMMARY OF THE INVENTION

A remote controller includes a board, first and second arms, an electrostatic touch panel placed on a first upper end of the first arm and a second upper end of the second arm, a push switch provided between the electrostatic touch panel and the board, a control section, and a transmitter transmitting a remote control signal. The first arm further a first lower end slidable on the upper surface of the board, and a first pivot provided between the first upper end and the first lower end. The second arm has a length equal to a length of the first arm, and includes a second lower end slidable on the upper surface of the board in an opposite direction to the first lower end, and a second pivot provided between the second upper end and the second lower end. The second pivot is located away from the second lower end by a distance between the first lower end and the first pivot. The second pivot is linked rotatably with the first pivot of the first arm. The touch panel has an upper surface and a lower surface facing the upper surface of the board. The upper surface of the touch panel is adapted to have a user touch thereon. The push switch is activated upon pressed with the touch panel. The control section detects a position on the upper surface of the electrostatic touch panel where the user touches. The transmitter transmits the remote control signal according to the detected position and an activation of the push switch.

This remote controller operates remotely control an electronic device reliably without malfunctioning.

### BRIEF DESCRIPTION OF THE DRAWINGS

FIG. 1 is a cross sectional view of a remote controller according to an exemplary embodiment of the present invention.

FIG. 2A is an exploded perspective view of the remote controller according to the embodiment.

FIG. 2B is an exploded perspective view of an electrostatic touch panel element of the remote controller according to the embodiment.

FIGS. 3A and 3B are a front view of an electronic device according to the embodiment.

FIG. 4 is a cross sectional view of the remote controller according to the embodiment while operating.

FIG. 5 is a cross sectional view of a conventional remote controller.

FIG. 6 is a cross sectional view of the conventional remote controller while operating.

FIG. 7 is a cross sectional view of the conventional remote controller in working.

### DESCRIPTION OF THE PREFERRED EMBODIMENT

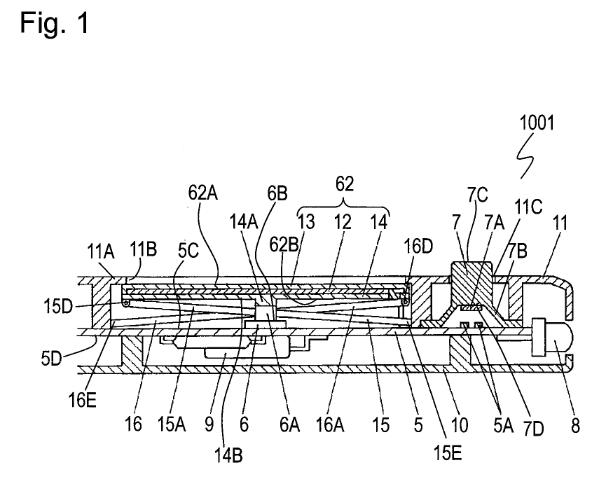

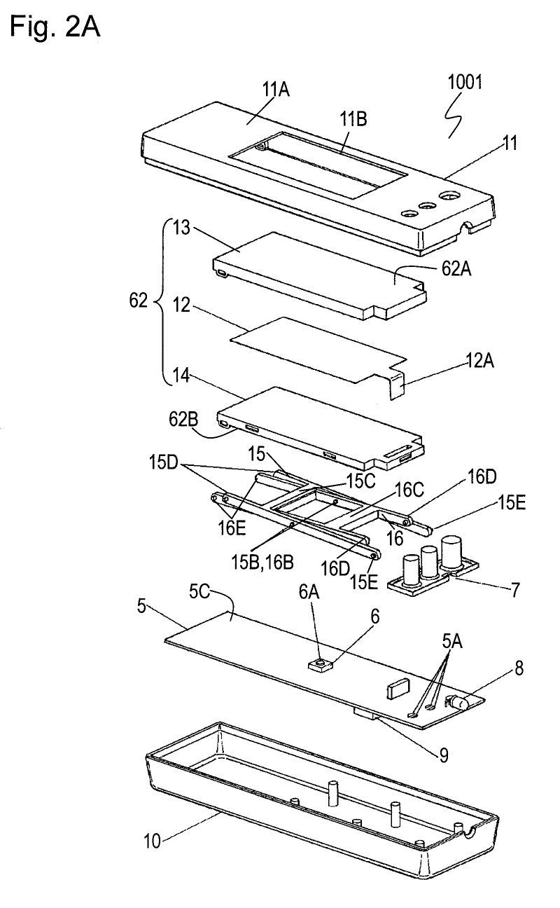

FIGS. 1 and 2A are a cross sectional view and an exploded perspective view of remote controller 1001 according to an exemplary embodiment of the present invention.

Case 11 is made of insulating resin, such as polystyrene or ABS resin, and has substantially a box shape. Opening 11B is formed in upper face 11A of case 11. Electrostatic touch panel 62 is mounted at opening 11B of case 11E. Electrostatic touch panel 62 includes upper cover 13 made of insulating resin, lower cover 14 made of insulating resin, and electrostatic touch panel element 12 accommodated between upper cover 13 and lower cover 14. Electrostatic touch panel 62 has upper surface 62A which is an upper surface of upper cover 13 and lower surface 62B which is a lower surface of lower cover 14 and opposite to upper surface 62A.

FIG. 2B is an exploded perspective view of electrostatic touch panel element 12. Electrostatic touch panel element 12 includes sheet 112 having a film shape, conductors 112C having substantially stripe shapes provide on upper surface 112A of sheet 112, and conductors 112D having substantially stripe shape provided on lower surface 112B of sheet 112. Conductors 112C extend in parallel each other. Conductors 112D extend in parallel with each other. Conductors 112C face conductors 112D across sheet 112 with a predetermined distance (the thickness of sheet 112), and extend perpendicularly to conductors 112D. Electrostatic touch panel element 12 includes tail 12A having electrodes connected with ends of conductors 112C and 112D. Tail 12A extending from the lower surface of lower cover 14 toward a right direction.

Circuit board 5 is made of insulating resin, such as paper phenol or glass epoxy. Wiring patterns made of conductive material, such as copper foil, are provided on upper surface 5C and lower surface 5D of circuit board 5. Push switch 6 is mounted onto upper surface 5C of circuit board 5. Tail 12A of electrostatic touch panel 62 is electrically connected to the wiring patterns of circuit board 5 via a connector. Push switch 6 includes push button 6A protruding from upper surface 6B of push switch 6. Push switch 6 is activated when push button 6A is pressed by a predetermined distance.

Each of frames 15 and 16 has substantially an H-shape and is made of insulating resin. Frame 15 includes two arms 15A extending in parallel with each other and bridge bar 15C fixedly coupling two arms 15A. Frame 16 includes two arms 16A extending in parallel with each other and bridge bar 16C fixedly coupling two arms 16A. Arm 15A and arm 16A has the same lengths. Electrostatic touch panel 62 is placed on upper end 15D of arm 15A and upper end 16D of arm 16A so that upper ends 15D and 16D are slidably movable on touch panel 62. Lower end 15E of arm 15A and lower end 16E of arm 16A are slidably movable on upper surface 5C of circuit board 5. Pivot 15B is provided at a middle portion of arm 15A between upper end 15D and lower end 15E. Pivot 16B is provided at a middle portion of arm 16A between upper end 16D and lower end 16E. Pivots 15B and 16B are linked with each other and joint arm 15A and 16A so that arm 15A and 16A can form an X-shape.

That is, Lower end 15E of arm 15A is slidable on upper surface 5C of board 5. Lower end 16E of arm 16A is slidable on upper surface 5C of board 5 in an opposite direction to lower end 1E of arm 15A. Pivot 16B is located away from lower end 16E by the distance between pivot 15B and lower end 15E of arm 15A. Pivot 16B is linked rotatably with pivot 15B. This arrangement causes electrostatic touch panel 62 to be held in parallel with upper surface 5C of circuit board 5. Electrostatic touch panel 62 has upper surface 62A adapted to have a user contact and lower surface 62B facing upper surface 5C of board 5. Upper end 15D is coupled with electrostatic touch panel 62 so that arm 15A rotates with respect to electrostatic touch panel 62. Upper end 16D is coupled with electrostatic touch panel 62 so that arm 16A rotates with respect to electrostatic touch panel 62.

Protrusion 14A protrudes from lower surface 14B of lower cover 14. Protrusion 14A contacts push button 6A protruding from upper surface 6B of push switch 6.

Button 7 is made of elastic insulating material, such as rubber or elastomer. Thin wall portion 7B having substantially a dome shape is provided at the lower portion of button 7. Upper surface 7C of button 7 protrudes movably in up and down directions through-hole 11C provided in upper face 11A of upper case 11. Movable contact 7A is provided on lower surface 7D of button 7. Fixed contacts 5A are provided on upper surface of circuit board 5. Fixed contacts 5A face movable contact 7A with a predetermined distance in between.

Transmitter 8 and control section 9 are mounted on upper surface 5C and lower surface 5D of circuit board 5. Transmitter 8 implemented by, e.g. a light emitting diode transmits a remote signal. Control section 9 is implemented by a semiconductor device, such as a microprocessor. Control section 9 is connected with transmitter 8, electrostatic touch panel 62, push switch 6, and fixed contacts 5A via the wiring patterns. Cover 10 made of insulating resin covers a lower surface of case 11.

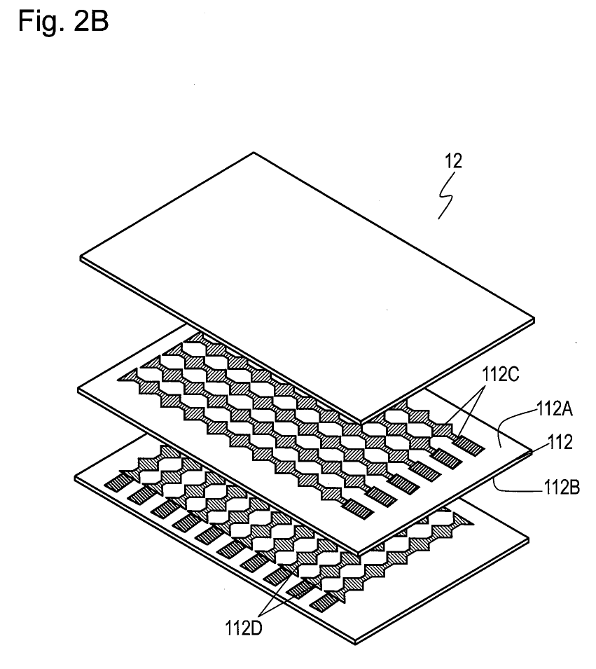

An operation of remote controller 1001 will be described below. FIGS. 3A and 3B are front views of electronic device 30 controlled by remote controller 1001. When a user has a finger press the upper surface of button 7 while directing remote controller 1001 toward electronic device 30, button 7 moves downward with elastic deformation of thin wall portion 7B. This allows movable contact 7A on lower surface 7D of button 7 to contact electrically fixed contacts 5A, thereby connecting fixed contacts 5A electrically with each other via movable contact 7A. In response to the electrical connection, control section 9 sends an infrared signal from transmitter 8 to electronic device 30 to control the device remotely, for example, to turn on and off the device or to control volume.

While options 31A, such as programs or menus, are displayed on a display screen 31 of electronic device 30, as shown in FIGS. 3A and 3B, the user touches upper surface 62A of electrostatic touch panel 62 with a finger and moves the finger in a front, back, left and right direction as if sliding on the upper surface to control the electronic device. Electrical charges of electrostatic touch panel element 12 of electrostatic touch panel 62 flow to the finger, so that the capacitance of the touch position of conductors 112C and 112D changes. In response, control section 9 detects the position where the user touches on upper surface 62A of electrostatic touch panel 62. Control section 9 sends a remote signal corresponding to the detected position from transmitter 8 to electronic device 30. Electronic device 30 then selects one of options 31A, such as programs or menus by moving cursor 32 or pointer 33 displayed on display screen 31 in response to the remote signal.

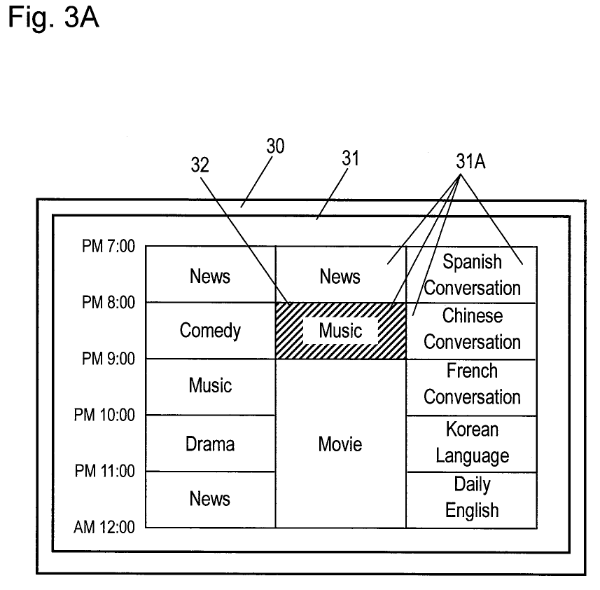

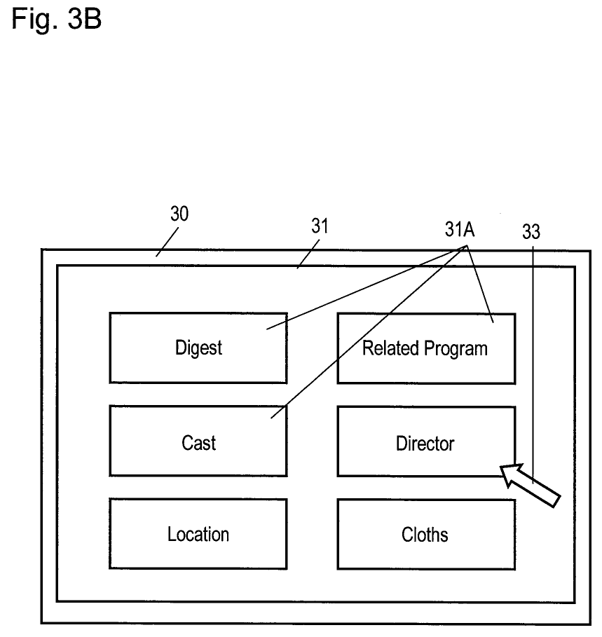

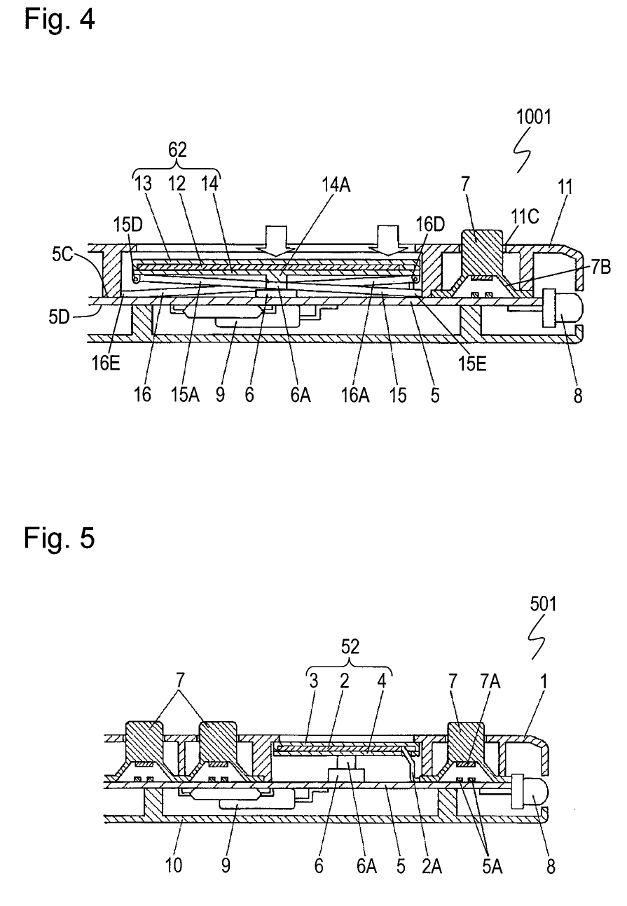

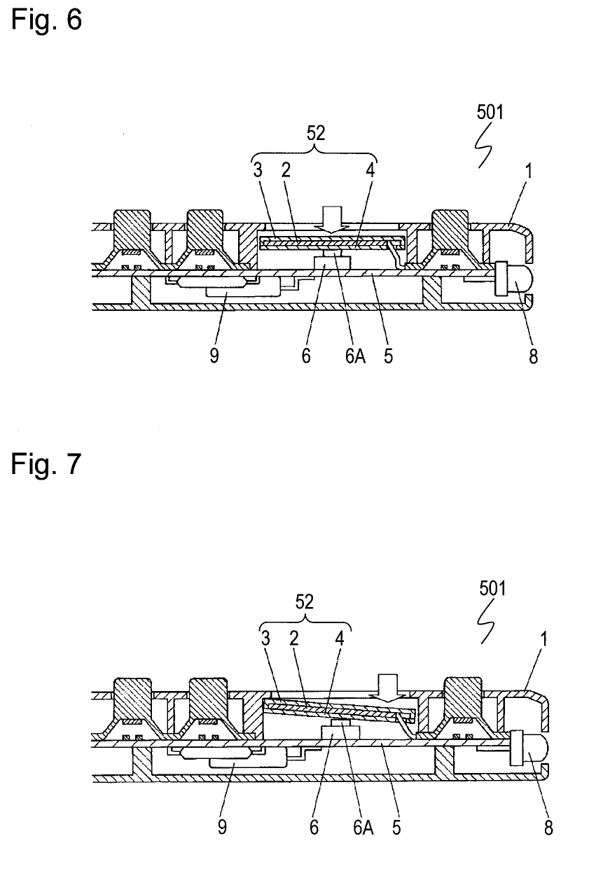

FIG. 4 is a cross-sectional view of remote controller 1001 while operating. While cursor 32 or pointer 33 is positioned at a desired one of options, such as programs or menus, the user presses upper cover 13, upper surface 62A of electrostatic touch panel 62 as shown in FIG. 4. Then, upper end 15D and 16D and lower end 15E and 16E of arm 15A and 16A of frame 15 and 16 rotate about pivots 15B and 16D and move towards outside. Electrostatic touch panel 62 placed on upper end 15D and 16D of arm 15A and 16A consequently moves downward to approach circuit board 5. As electrostatic touch panel 62 moves downward, protrusion 14A protruding from lower surface 62B presses push button 6A of push switch 6 and activates push switch 6. Control section 9 detects the activation of push switch 6 and directs transmitter 8 to transmit a remote control signal to electronic device 30, fixing the desired one in options 31A, such as programs or displaying the next menu.

As described above, remote controller 1001 remotely controls various functions, such as power switching and volume control, of the electronic device by pressing button 7, selecting a menu, such as programs, displayed on display screen 31 by touching electrostatic touch panel 62, and further determining the menu or display the next menu by pressing electrostatic touch panel 62.

As shown in FIG. 4, even when a periphery of electrostatic touch panel 62 is pressed instead of a center thereof, arm 15A and 16A of frame 15 and 16 rotate about pivots 15B and 16B, and cause electrostatic touch panel 62 to be parallel with circuit board 5 while moving downward to approach circuit board 5. Protrusion 14A provided on lower surface 62B of lower cover 14 presses push button 6A of push switch 6 in a direction perpendicular to circuit board 5. Thus, push button 6A of push switch 6 is moved reliably by the predetermined distance enough to activate push switch 6, thereby activating push switch 6 stably and preventing the remote controller 1001 from malfunctioning.

Arm 15A of frame 15 has the same length as arm 16A of frame 16. Arm 15A crosses arm 16A at the middle portion of arm 15A between upper end 15D and lower end 15E and at the middle portion of arm 16A between upper end 16D and lower end 16E. Arms 15A and 16A are linked rotatably about pivots 15B and 16B. As the user presses upper surface 62A of electrostatic touch panel 62 with a finger, arm 15A and 16A rotate about pivots 15B and 16B. Upper end 15D and 16D move towards outside to be removed from each other. Lower end 15E and 16E move towards outside to be removed from each other. As the user stop pressing upper surface 62A of electrostatic touch panel 62, arm 15A and 16A rotate about pivots 15B and 16B. Upper end 15D and 16D moved towards inside to approach each other. Lower end 15E and 16E move towards inside to approach each other. This movement allows electrostatic touch panel 62 to move in parallel with circuit board 5. The lengths of arm 15A and 16A are equal to each other. Pivot 15B is located at the middle portion of arm 15A between upper end 15D and lower end 15E. Pivot 16B is located at the middle portion of arm 16 between upper end 16D and lower end 16E. According to the embodiment, arm 15A and 16A has the lengths equal to each other, and a distance between pivot 15B and upper end 15D of arm 15A is equal to a distance between pivot 16B and upper end 16D of arm 16A. This arrangement allows electrostatic touch panel 62 to always move in parallel with circuit board 5, thus activating push switch stably without causing a malfunctioning.

A spring made of material identical to that of button 7 or made of metal may be placed between lower surface 62B of electrostatic touch panel 62 and upper surface 5C of circuit board 5. The spring elastically urges electrostatic touch panel 62 upward away from circuit board 5. The spring allows electrostatic touch panel 62 to move upward and downward so that the panel can move reliably toward circuit board 5 and away from circuit board 5. The spring allows the user to touch upper surface 62A of electrostatic touch panel 62 easily. Control section 9 can reliably detect the position where the user touches, accordingly control electronic device 30 remotely.

Push switch 6 of remote controller 1001 includes push button 6A to activate push switch 6. In remote control 1001 according to the embodiment, push switch 6 may includes fixed contacts placed on upper surface 5C of circuit board 5 and a movable contact facing the fixed contacts with a predetermined distance in between. Push switch 6 may includes a fixed contact provided on upper surface 5C of circuit board 5 and a movable contact made of conductive thin metal having a dome shape placed above the fixed contact.

According to the embodiment, terms indicating directions, such as “upper surface” and “lower surface” indicate relative direction depending on positional relationship between components, such as electrostatic touch panel 62 and circuit board 5, of remote controller 1001, and do not indicate absolute directions, such as a vertical direction.

What is claimed is:

1. A remote controller comprising:
a board having an upper surface;
a first arm including
a first upper end,
a first lower end slidable on the upper surface of the board, and
a first pivot provided between the first upper end and the first lower end;
a second arm having a length equal to a length of the first arm, the second arm including
a second upper end,
a second lower end slidable on the upper surface of the board in an opposite direction to the first lower end, and
a second pivot provided between the second upper end and the second lower end, the second pivot being located away from the second lower end by a distance between the first lower end and the first pivot, the second pivot being linked rotatably with the first pivot of the first arm;
an electrostatic touch panel placed on the first upper end and the second upper end, the touch panel having an upper surface and a lower surface facing the upper surface of the board, the upper surface of the touch panel being adapted to have a user touch thereon;
a push switch provided between the electrostatic touch panel and the board, the push switch being activated upon pressed with the electrostatic touch panel;
a control section detecting a position on the upper surface of the electrostatic touch panel where the user touches; and
a transmitter transmitting a remote control signal according to the detected position and an activation of the push switch.

2. The remote controller according to claim 1, wherein the first upper end is coupled with the electrostatic touch panel so that the first arm is rotatable with respect to the electrostatic touch panel.

3. The remote controller according to claim 2, wherein the second upper end is coupled with the electrostatic touch panel so that the second arm is rotatable with respect to the electrostatic touch panel.

4. The remote controller according to claim 1, further comprising:
a third arm extending in parallel with the first arm and has a length equal to the length of the first arm, the third arm including
a third upper end,
a third lower end slidable on the upper surface of the board in a same direction as the first lower end, and
a third pivot provided between the third upper end and the third lower end, the third pivot being located away from the third lower end by a distance between the first lower end and the first pivot;
a fourth arm extending in parallel with the second arm and has a length equal to the length of the third arm, the fourth arm including
a fourth upper end,
a fourth lower end slidable on the upper surface of the board in an opposite direction to the third lower end, and
a fourth pivot provided between the fourth upper end and the fourth lower end, the fourth pivot being located away from the fourth lower end by a distance between the first lower end and the first pivot, the fourth pivot being linked rotatably with the third pivot of the third arm;
a first bridge bar fixedly coupling the first arm with the third arm; and
a second bridge bar fixedly coupling the second arm with the fourth arm.

5. The remote controller according to claim 4, wherein the third upper end is coupled with the electrostatic touch panel so that the third arm is rotatable with respect to the electrostatic touch panel.

6. The remote controller according to claim 5, wherein the fourth upper end is coupled with the electrostatic touch panel so that the fourth arm is rotatable with respect to the electrostatic touch panel.
